(19) United States
(12) Patent Application Publication
(10) Pub. No.: US 2007/0193870 A1
(43) Pub. Date: Aug. 23, 2007

(54) SOLAR-POWERED DESALINATION SYSTEM

(76) Inventor: Melvin L. Prueitt, Los Alamos, NM (US)

Correspondence Address: Melvin Prueitt, 161 Cascabel St., Los Alamos, NM, 87544, US

(21) Appl. No.: 11/668,084

(22) Filed: Jan. 29, 2007

Related U.S. Application Data
(60) Provisional application No. 60/775,504, filed on Feb. 21, 2006.

(51) Int. Cl. B01D 3/14

(52) U.S. Cl. 202/176; 159/32; 202/234; 202/173; 202/154; 202/155

(57) ABSTRACT

This invention has a series of multiple parallel plates that form desalination chambers between them that have seawater or other saline water flowing down the inside of one plate of each chamber. Steam which is generated by solar heat or other heat source condenses on the outside of first chamber of the series on the plate, which has seawater running down it. This releases heat that evaporates the seawater. The vapor flows to the other wall (plate) of the desalination chamber and condenses, and this releases heat that flows through the plate to the next stage of parallel plates and evaporates seawater flowing down the other side of the plate. Each succeeding stage operates at a lower temperature than the previous stage. The final stage is cooled by the evaporation of seawater into the air. One embodiment of the invention has the parallel plates sloped at an angle to the horizontal so that the seawater flows down on the lower plate and evaporates with heat supplied from below. The vapor condenses on the ceiling of the chamber. Since each succeeding stage upward is at a lower temperature, the vapor pressure will be lower in succeeding stages. This pressure differential can be used to pump the seawater from one stage to the next higher stage.

### CROSS-REFERENCE TO RELATED APPLICATION

This claims priority to and the benefit of Provisional U.S. Patent Application Ser. No. 60/775,504, filed Feb. 21, 2006, the entirety of which is hereby incorporated herein by reference.

### BACKGROUND OF THE INVENTION

There are patents disclosing desalinating devices that consist of a number of vertical plates with small chambers between the plates. For example, U.S. Pat. Nos. 3,522,151, 4,402,793 and 4,329,204 show methods of having films of seawater flow down vertical plates. Saline water flows down one side of each plate. Heat is applied to the outside of a chamber (say on the left side of the device). The heat flows through the first plate and evaporates saline water flowing as a film on the right side of the plate. The water vapor crosses the gap to the second plate and condenses on that plate and releases the heat of condensation into that plate. The condensed water flows down the left side of second plate and is collected at the bottom as fresh water. The released heat of condensation evaporates the saline water flowing down the right side of the second plate, and that vapor flows to the third plate, where it condenses. The process continues through each stage until it comes to the last stage. The last plate is cooled on the right side (outside) by cool water or other means.

U.S. Pat. Nos. 3,930,958, 4,475,988, and 5,094,721 show methods of having horizontal parallel desalination chambers. U.S. Pat. No. 6,355,144 shows a method of desalination using sloping parallel plates.

The advantage of the parallel plate desalinator is that the input heat is used over and over again as it traverses each stage. One of the disadvantages is that the saline water that is introduced at the top is preheated, and some of that heat is not used as many times as there are stages. That is, the heat of the hot saline water that enters the first stage through plate 1 of the device is used as many times as there are stages, but the heat of the hot water entering the last stage (cool side) is used only once. Another problem with the design is that if the gaps between plates are initially evacuated, the hot water entering the cold stage would flash vigorously and would tend to splash saline water to the fresh water surface. Also, if the system relies on an airless internal environment, air that is dissolved in the water will come out of solution and remain in the gaps. This air is pushed toward the freshwater side of each stage by the flow of water vapor. As the air accumulates against the freshwater film, it retards the flow of water vapor.

One way to eliminate the problems described in the previous paragraph would be to heat the saline water entering the first stage (hot side) and then when the hot saline water reaches the bottom, pump the water to the next stage, etc. This uses the water heat more efficiently, but it requires a pump for each stage. If there are 20 stages, the system becomes complex and uses power to drive 20 pumps.

### SUMMARY OF THE INVENTION

The invention that is the subject of this description seeks to overcome these problems. It is called “SunDesal” herein. Even though the preferred embodiments use solar energy to provide the heat, it should be understood that other sources of heat could replace the solar energy.

One embodiment of SunDesal uses the vapor pressure differentia between stages to cause the water to flow from one stage to the next. By having the stages slanted rather than vertical, the water flow rate is slower and allows more time for evaporation. This also helps the water film to spread out on the plates.

Another embodiment of the present invention uses baffle plates within each stage to direct the flow of vapor such that the vapor carries the entrapped air to one end of each stage so that the air can be removed. This eliminates the need for deaeration before the water enters the desalination device.

Another embodiment of the present invention conducts the incoming seawater through heat exchangers and through a pipe in each desalination chamber to preheat the water to the appropriate temperature for that chamber. Float valves are used to control the inflow of seawater from a single pump.

Each of these embodiments could be used to produce water from the atmosphere by having a separate unit that collects water by a hydrophilic liquid, such as sulfuric acid or a zinc chloride solution. The aqueous solution is then pumped through the desalination unit and distilled.

It is therefore an objective of the invention is to efficiently use the supplied heat to desalinate seawater or other aqueous solution by using the same heat multiple times at sequentially lower temperatures.

It is another objective of the present invention is to eliminate an excessive number of pumps while desalinating water efficiently.

It is another objective of the present invention is to provide a compact desalination unit by having closely spaced parallel plates that separate the desalination chambers.

It is another object of the present invention to provide a means of removing entrapped air in the water vapor without having to deaerate the saline water before introducing the water into the desalination unit.

It is another objective of the present invention to use evaporating seawater to remove the heat from the desalination unit after the heat has left the final stage.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate embodiments of the present invention and, together with the description, serve to explain the principles of the invention. The drawings are only for the purpose of illustrating preferred embodiments of the invention and are not to be construed as limiting the invention. In the drawings:

FIG. 1 is a cross-sectional side-view schematic of one embodiment of the present invention in which the parallel plates and desalination chambers are slanted with respect to the horizontal.

FIG. 2 is a bottom view schematic of one of the plates that separate the desalination chambers showing cords that use capillary action to collect condensed water and carry it to side troughs.

FIG. 3 is a side-view schematic drawing of a u-shaped pipe that prevents vapor from flowing from one stage to the next.

FIG. 4 is a cross-sectional side-view schematic of another embodiment of the present invention in which baffle plates are inserted within each desalination chamber to guide the vapor flow so that all entrapped air will be delivered to the vent pipes.

FIG. 5 is a cross-sectional side-view schematic of another embodiment of the present invention in which the parallel plates and desalination chambers are vertical.

FIG. 6 is a side-view schematic of a simple float valve for permitting water to leave the desalination chambers.

### DETAILED DESCRIPTION OF THE INVENTION

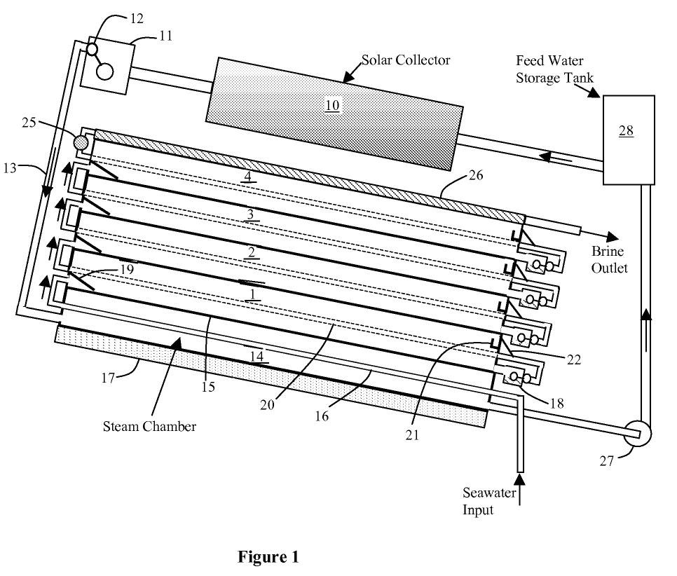

FIG. 1 shows a schematic of this embodiment of SunDesal. For small systems, the solar collector could be a solar trough or even a flat solar collector. For large desalination plants, solar trough collectors or a conical collector called “Suncone” can be used to generate steam. For conditions in which the water does not reach the boiling point (100° C.), steam can still be generated at lower temperatures by lowering the pressure.

The SunDesal unit consists of a number of flat plates that separate the stages of the unit. The first stage (bottom stage) is the hottest, and each stage above that is progressively cooler. The top stage is cooled by evaporation of water that flows down the evaporation tray, or it can be cooled by cold water flow.

In FIG. 1, heat is collected by the solar collector 10. A steam control unit 11 has a float valve 12, which prevents the heated fluid from going to the desalination unit until the fluid becomes vapor. That is, at startup, the solar collector 10 and the steam control unit 12 are filled with water. As the water in the collector boils, the steam bubbles up to the steam control unit. When sufficient steam is present, float valve 12 opens and steam flows down pipe 13 and into the steam chamber 14 at the bottom of the distillation unit. Seawater or brackish water flows through a seawater pipe 16 that passes through the steam chamber 14 and is heated by steam that condenses on the pipe. Steam also condenses on the upper plate 15 of the steam chamber. That plate separates the steam chamber from the first stage (1). The water that condenses on the seawater pipe 16 and the bottom of plate 15 flows down to the right end of the steam chamber and to pump 27, where it is pumped back to the feed water storage tank 28, ready to reenter the solar collector.

The condensation of steam on the ceiling (plate 15) of the steam chamber 14 releases heat that heats the film of preheated seawater that is flowing down the floor of the first stage 1. That causes the water to evaporate in the evacuated chamber of the first stage, and it condenses on the ceiling of the first stage. The condensed water flows as a film down the ceiling and is collected in the freshwater tray 21 at the right side of the drawing. From there, it is conducted by a pipe (not shown) to a freshwater storage tank.

The splash guard 19 covering the entrance of seawater into each stage is designed to catch any saline droplets that might result from any flashing of the water, since the water is entering a stage with lower pressure than the pressure in the previous stage. The splash guard is also designed to spread the water out evenly across the plate.

The condensation of water on the ceiling of the first stage 1 releases heat that is conducted to the floor of the second stage 2. Since the second stage is cooler than the first stage, its vapor pressure will be less, so the seawater that flows down the floor of the first stage 1 will be forced to flow up through pipe 20 to the second stage. There it will flow down the floor of the second stage and evaporate due to the heat supplied from below. The process is repeated through stages 2 and 3 until the water reaches the last stage 4, which has the lowest pressure. After the seawater (now brine) leaves the last stage 4, it is pumped by pump 25 to the evaporation tray 26 on top. The brine flows as a film down the evaporation tray and evaporates, providing cooling for the last stage 4. If there is insufficient wind, a fan can blow air across the tray. Although only four stages are shown, it should be understood that there may be many more stages.

Notice that there is a float valve assembly 18 at the right end of each stage. That prevents vapor from flowing to the next stage. The float valve will open to let water flow only when there is sufficient water in the float valve assembly 18. Since the vapor pressure in the first stage is higher than that of the second stage, the water will be forced to flow from the first stage to the second stage. The process is repeated in the higher stages. The seawater pipes do not go through the spaces between the plates but passes around the unit (represented by dashed lines).

We see that we can cause the water to flow up to all the stages without having to install pumps. Only one pump is required to move the seawater: the one that pumps the water out to the evaporation tray (since the ambient pressure is higher than the pressure in the last stage). Another pump is required to pump the boiler feed water to the feed water storage tank 28.

The drawing is not to scale. The spacing between the plates might be an inch, and the length of the plates from left to right might be eight to ten feet. The left end of each plate, which might be two feet wide, might be a foot higher than the right end. As an example, suppose that the first stage has a temperature of 100° C. and the second stage has a temperature of 98° C., the pressure differential will be 1.019 psi. That is sufficient to lift water by a height of 2.35 feet.

If a SunDesal unit consists of 20 stages (rather than 4 as shown in FIG. 1) and each stage is one inch tall, the stack would be 21 inches tall (including the steam chamber). Add the one-foot elevation of one end, and the total height would be about three feet tall, including a base structure and the evaporation tray. The solar collector would probably be placed beside the desalination unit. Such a unit could produce about 3,000 gallons per 10-hour day of fresh water from seawater. It would require about 36 kilowatts of solar power.

To sustain the pressure on the plates, periodic spacers (which could be small rods) are placed between the plates. The floor of the evaporation tray can be thick metal and can also have some external bracing.

The hot fresh water leaving the device can be used to preheat the incoming seawater in a heat exchanger (not shown).

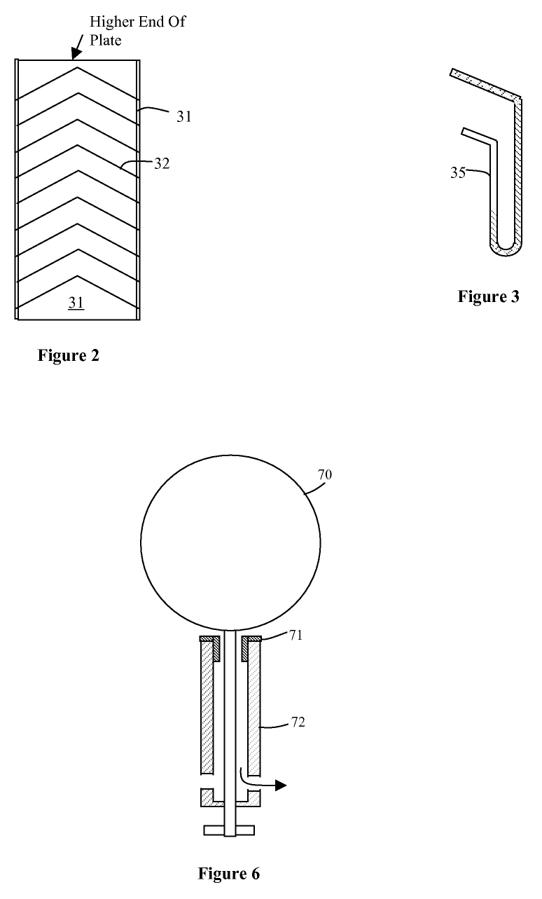

As the condensed water flows down the sloping ceiling of each stage, water drops may drip down. FIG. 2 shows the underside of the plate. The underside of each stage can have diagonal strings or cords 32 that collect the water by capillary attraction and conduct the water to side troughs 31. This prevents water from dripping down to the bottom of the chamber. The top surface of each plate 31 should have parallel strings that run the length of the plate to help provide a uniform distribution of the seawater film running down the top of the plate.

To simplify the design, instead of having boxes with float valves (float valve assembly 18 of FIG. 1) at the right of each stage, a simple U-shaped copper tube 35 in FIG. 3 could provide a barrier to the vapor flow from one stage to the next. The U-shaped tube might be two feet tall. The pressure differential between states would push the water level on one side of the tube down to sustain the pressure.

Within each stage of the distillation unit, water vapor passes from the flowing film of seawater to the ceiling of the stage and condenses as fresh water. Any air that comes out of solution will be carried along with the water vapor. Since the hot water enters from the left in FIG. 1, the left end will be slightly warmer than the right end. There will be a migration of vapor and air toward the right. A constricted vent pipe 22 allows a small amount of vapor and air to flow into the seawater pipe to the next stage. In this manner, the air will be transported from stage to stage until it is pumped out by the exhaust pump 25.

If the solar collector is lower than the desalination unit, the feed water pump can be eliminated, because the condensed steam (boiler feed water) would flow by gravity back to the solar collector.

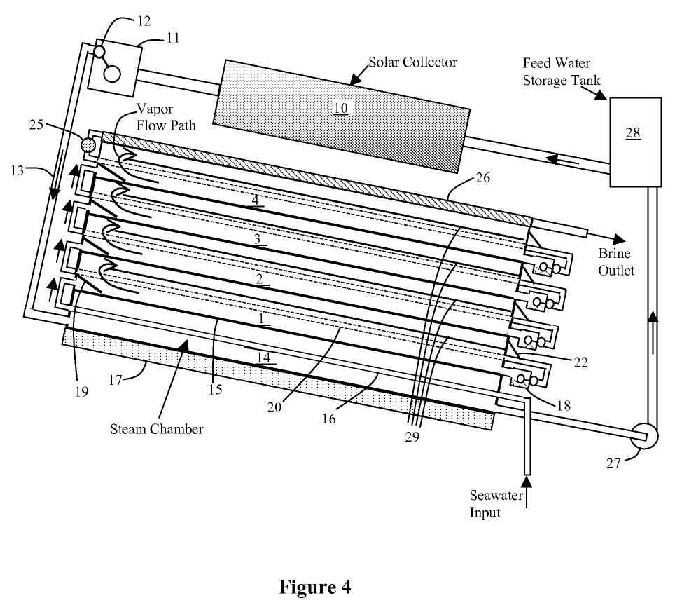

Another embodiment of the present invention is shown in FIG. 4. It is similar to the embodiment of FIG. 1, but it has baffle plates 29 that cause the vapor from the bottom of each stage to flow up to the left in the drawing and around the ends of the baffle plates. The vapor then flows to the right below the ceiling of each stage. The purpose of this is to force all air that is trapped in the vapor to flow to the right and be vented through the vent pipes 22. Since there will be a rapid flow of vapor to the right beneath the ceilings, the air will not become stagnant against the surface on which the vapor is condensing.

An additional purpose of the baffle plates 29 is to act as a catch tray for condensed water that drips off the ceiling. Note that the catch troughs 21 of FIG. 1 are not present in FIG. 4. The water that runs down the baffle plates 29 drain off through drain pipes on each side (not shown). In this embodiment, the water collection strings of FIG. 3 are not necessary.

### Water Producer

The SunDesal system can be adapted for the production of water from the air. This system will be valuable to areas that do not have seawater or brackish water available. A hygroscopic liquid, such as sulfuric acid or a solution of zinc chloride absorbs water from the air. This liquid can then be pumped through SunDesal in the place of seawater. The heat from the solar-produced steam can then drive the water vapor from the liquid, and the water vapor would condense as fresh water.

Air is blown through the water-collecting unit, which provides large areas of exposure to the hygroscopic liquid. Since the relative humidity is normally higher at night, it is better to collect the water at night. Then in the daytime, the liquid is pumped through SunDesal to recover the water.

As an example, if the temperature is 30° C. and the relative humidity at night is 60%, a water collector with a 10 by 10 meter opening that has air blowing through at 10 meters/second would collect 12 kg of water per second, if it extracted 75% of the available water in the air. For 12 hours of collection, that amounts to 518,400 kg of water. The SunDesal unit would extract that water the next day to produce 137,000 gallons of water. To produce a million gallons per day of water from the air, it would require a water collector that is 73 meters long and 10 meters high. It would consist of inexpensive, closely-spaced layers over which the liquid would flow. It would be advantageous to have the opening facing toward prevailing winds.

### Vertical Multi-Stage Distiller

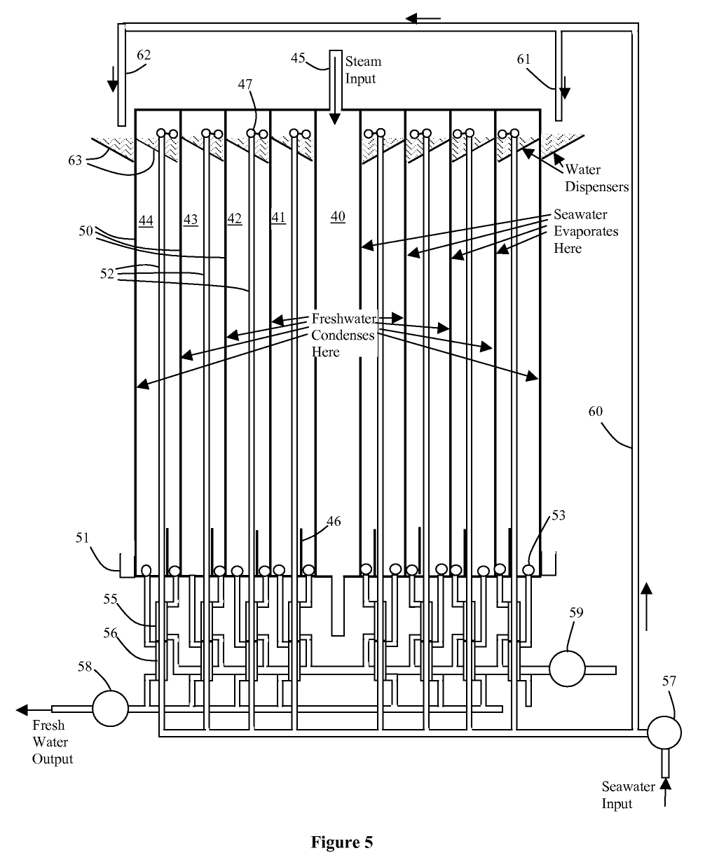

In the introduction, some of the disadvantages of distillation devices with multiparallel-plates were discussed. Another embodiment of the present invention, illustrated in FIG. 5, overcomes some of the disadvantages. It does require pump 57 to pump the seawater to the top of the device, and it requires pump 58 to pump the freshwater out to a tank and requires pump 59 to pump brine out of the evacuated system.

Seawater (or brackish water) is pumped through heat exchangers 55 and 56 to each stage in order to preheat the seawater. The seawater pipes 52 pass through the gaps between the plates that separate the stages. Here the seawater is heated as water vapor condenses on the outside of the pipes 52. This condensed water flows down the outside of the pipes and is collected at the bottom as fresh water. The seawater arrives at the top heated to the appropriate temperature for each stage.

The heated seawater flows up pipes 52 through float valves 47 and past dispensers 63. The water flows down the plates 50 and is evaporated by heat supplied through the plates. Steam enters the center of the device through pipe 45 and heats the plates on each side of steam chamber 40. The heat evaporates seawater films flowing down the plates, and the vapor flows to the other side of the stage and condenses on the next plate. For example, heat from condensing steam on the left wall of steam chamber 40 flows through the wall into stage 41. Seawater flowing down the right wall of stage 41 is heated and partially evaporates. The vapor condenses on the left wall of stage 41 and releases heat that flows through the wall to stage 42, where the process is repeated. This continues through stages 43 and 44. The left side of stage 44 is cooled by down-flowing seawater, which evaporates to provide sufficient cooling on the surface of the outside plate 50. Cool seawater flows up pipe 60 and down pipes 61 and 62 to dispensers 63 where it spreads out on the outside plates. The seawater is collected by troughs 51 at the bottom. Similar processes take place on the right half of the device.

Since the pressure of each stage is different, float valves 53 are necessary at the bottom to prevent vapor from flowing out. The fresh water pump 58 must provide sufficiently low pressure to draw water out of the lowest-pressure stage. Separator plates 46 separate the down flow of fresh water and seawater. Since the seawater is hotter than the fresh water in each stage, the seawater flows into the top heat exchanger 55 to preheat the incoming seawater. The fresh water flows to the bottom heat exchanger 56 to release its excess heat to the seawater. These heat exchangers can be simple concentric tube heat exchangers.

Float valves 47 are necessary at the top of each stage so that the driving force that causes the water to flow down at a certain rate is determined by the depth of water at the top rather than by the vapor pressure differential.

This device uses the evaporation heat repeatedly as it flows through the stages, and it recovers the heat of the freshwater and the brine that arrive at the bottom. There can be many more stages than those shown in FIG. 5. Rather than having the stages separated by flat plates, the device might be formed of concentric cylinders.

Since quite a few float valves are necessary, a simple design like that of FIG. 6 would make them inexpensive. It consists of a float 70, an outflow pipe 72, and a gasket 71. If there is not room inside the narrowly spaced plates, the float valves can be placed below the stages and can be staggered in position normal to the page. The float 70 must be large enough to overcome the pressure that tries to keep the valve closed.

To provide a method of deaerating the water vapor similar to the method provided by the baffle plates of FIG. 4, the separator plates 46 of FIG. 5 can be extended to near the top of the desalination chambers. The air, along with some vapor, can be removed through a vent pipe near the bottom of the desalination chamber where the fresh water is drained (not shown).

What is claimed:

1. A desalination system, comprising:
a heat source, which could be a solar collector, for boiling water to produce steam; and
a set of parallel plates forming narrow chambers between the plates, which are sealed against ambient air, the steam chamber of which receives the steam and provides heat to the first desalination chamber by the condensation of steam on the parallel plate that separates the steam chamber from the first desalination chamber, which first desalination chamber evaporates water from seawater (or other aqueous solution) flowing as a film on one parallel plate and condenses fresh water on another parallel plate; and
a series of desalination chambers formed between the other parallel plates, which desalination chambers use the heat of the condensation of water vapor from the previous desalination chamber to evaporate seawater flowing on one parallel plate and condenses the water vapor to fresh water on another parallel plate, each desalination chamber being at lower temperature than the previous desalination chamber; and
an evaporation tray formed with the final parallel plate adjacent to the last desalination chamber wherein a film of seawater flows on the evaporation tray and removes heat from the desalination system by evaporation of water into the ambient air.

2. A desalination system of claim 1, wherein the parallel plates are sloped at angle to the horizontal and wherein the steam chamber is located between the lowest two parallel plates and wherein the desalination chambers are located between parallel plates above the steam chamber, and each successively higher chamber operates at successively lower temperatures and lower vapor pressures and wherein seawater flows down on the top of the lower parallel plate of each evaporation chamber and evaporates, and water vapor condenses on the upper parallel plate of each desalination chamber.

3. A desalination system of claim 2, wherein incoming seawater is heated by condensation of steam on the pipe containing the incoming seawater in the steam chamber in order to preheat the seawater before the seawater enters the first desalination chamber.

4. A desalination system of claim 2, wherein the higher vapor pressure of lower desalination chambers force the seawater to flow up to the next higher desalination chamber and wherein the seawater leaving the highest desalination chamber is pumped out to the evaporation tray.

5. A desalination system of claim 2, wherein float valves prevent seawater from flowing from one desalination chamber to the next higher desalination chamber, unless sufficient seawater is present, in order to prevent water vapor from flowing from one desalination chamber to the next.

6. A desalination system of claim 2, wherein constricted vent pipes bleed entrapped air from one desalination chamber to the next.

7. A desalination system of claim 2, wherein the underside of the upper parallel plate of each desalination chamber has attached fibrous cords, which collect condensed water by capillary attraction and deposits the water in troughs at the sides of the plates.

8. A desalination system of claim 2, wherein a steam control unit prevents water or steam from flowing from the boiler to the steam chamber if insufficient steam is available.

9. A desalination system of claim 5, wherein a u-shaped pipe is substituted for the float valve assembly wherein differential heights of seawater on each side of the u-shaped pipe prevent the flow of vapor from one desalination chamber to the next.

10. A desalination system according to claims 2 through 9, wherein a baffle plate is inserted between and parallel to the parallel plates of each desalination chamber, which baffle plate extends from the lower end to near the upper end of each desalination chamber in order to force the water vapor that evaporates from the bottom parallel plate of each desalination chamber to flow from the bottom parallel plate around the end of the baffle plate near the upper end of the upper parallel plate and then flow toward the lower end of the upper parallel plate so that the vapor sweeps entrapped air in the water vapor toward the lower end of the desalination chamber where the entrapped air is removed by the vent pipes of claim 6.

11. A desalination system of claim 10, wherein the baffle plates additionally serve as catch trays to capture condensed water drops that fall from the parallel plates immediately above the baffle plates.

12. A desalination system of claim 1, wherein the parallel plates are mounted vertically and wherein steam enters the chamber between the center two parallel plates and wherein seawater flows down the parallel plates on either side of the steam chamber on the opposite surface from the steam chamber and wherein the condensation of steam on the parallel plates provides heat to evaporate the seawater and wherein the evaporated water condenses on the next outwardly parallel plate and releases heat for the next outwardly desalination chamber and wherein the condensed fresh water flows down to the bottom of the desalination chamber to be collected for use.

13. A desalination system of claim 12, wherein the hot seawater and hot fresh water flowing down the parallel plates are collected at the bottom of the desalination chambers and flow through heat exchangers to heat the incoming seawater, which seawater then flows up through a pipe inside each desalination chamber and is further heated by condensation of water vapor on the outside of the pipe, and which heated seawater flows up to float-valve-controlled water dispensers that dispense seawater to the hotter parallel plate in the desalination chamber below.

14. A desalination system of claim 12, wherein float valves at the bottom of each desalination chamber prevent seawater and fresh water from exiting when insufficient water is present.

15. A desalination system of claim 12, wherein seawater dispensers cause cool seawater to flow as a film down the outside of the outer parallel plate on each side of the desalination unit for the purpose of removing the condensation heat of the last desalination chamber by evaporation of water in the ambient air.

16. A desalination system of claim 12, wherein separator plates are placed within each desalination chamber at the bottom to separate the fresh water from the seawater.

17. A desalination system according to claim 16, wherein the separator plates are elongated to extend to near the top of the desalination chamber in order to force the evaporating water vapor from the seawater side of the chamber to flow up around the separator plate and down the freshwater side of the chamber so that the vapor sweeps entrapped air in the water vapor toward the bottom end of the desalination chamber where the entrapped air is removed by vent pipes.

18. A desalination system according to claims 12 through 17, wherein the vertical parallel plates are replaced by vertically oriented cylinders placed concentrically so that the desalination system has cylindrical geometry.

19. A desalination system of claim 1, wherein an aqueous solution is produced by collection of water from the air by a hygroscopic material and wherein the aqueous solution replaces seawater in the desalination unit to be distilled to produce fresh water.

20. A desalination system of claim 1, wherein the heat source provides hot water or other hot fluid instead of steam to flow into the equivalent of the steam chamber to supply the heat to drive the system.
